(19) United States
(12) Patent Application Publication
(10) Pub. No.: US 2024/0276326 A1
(43) Pub. Date: Aug. 15, 2024

(54) USER EQUIPMENT, BASE STATION, AND METHOD FOR LOSSLESS MBS TRANSMISSION BASED ON PDCP SYNCHRONIZATION DURING HANDOVER

(71) Applicant: Huizhou TCL Cloud Internet Corporation Technology Co., Ltd., Huizhou (CN)

(72) Inventors: SALIH AHMED MOHAMMED MIKAEIL, Huizhou (CN); Jia SHENG, Huizhou (CN)

(73) Assignee: Huizhou TCL Cloud Internet Corporation Technology Co., Ltd., Huizhou (CN)

(21) Appl. No.: 18/642,338

(22) Filed: Apr. 22, 2024

Related U.S. Application Data
(63) Continuation of application No. PCT/CN2021/125906, filed on Oct. 22, 2021.

(51) Int. Cl. H04W 36/02; H04W 36/00; H04W 36/08

(52) U.S. Cl. CPC H04W 36/02; H04W 36/0007; H04W 36/08

(57) ABSTRACT

Embodiments are directed towards communication methods for lossless MBS transmission based on PDCP synchronization during handover. Combined mapping information including mapping information of GTP-U SNs and PDCP SNs, as well as mapping information of QoS flow IDs and MRB/DRB IDs is exchanged/shared between source RAN node and target RAN nodes to achieve such lossless transmission. UEs and base stations with processors configured to perform such methods are also introduced.

### TECHNICAL FIELD

The present disclosure relates to wireless communication systems, and more particularly, but not exclusively, to user equipment, base station and method for lossless MBS transmission based on PDCP synchronization during handover.

### BACKGROUND

Multicast/Broadcast Services (MBS) is expected to cover diversity of 5G applications and services ranging from public safety, mission critical, V2X, transparent IPV4/IPv6 multicast delivery, IPTV, software delivery over wireless to group communications and IoT applications. As a part of 5G NR R17 standardization, a new working item is approved WID [RP-201308] targeting RAN's support of MBS.

### BRIEF SUMMARY

Briefly stated, embodiments are directed towards communication methods for lossless MBS transmission based on PDCP synchronization during handover. Combined mapping information including mapping information of GTP-U SNs and PDCP SNs, as well as mapping information of QoS flow IDs and MRB/DRB IDs is exchanged/shared between source RAN node and target RAN nodes to achieve such lossless transmission. UEs and base stations with processors configured to perform such methods are also introduced.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings:

FIG. 1 illustrates two kinds of deliveries of MBS user data;

FIG. 2 illustrates multiple MBS QoS flows corresponding to a same MBS session mapped to one or more MRB/DRB;

FIG. 3 illustrates an example communication system according to one embodiment of the present disclosure;

FIG. 4 illustrates a one-to-one mapping mode according to one embodiment of the present disclosure;

FIG. 5 illustrates a one-to-many mapping mode according to one embodiment of the present disclosure;

FIG. 6 illustrates a flow diagram of a communication method according to one embodiment of the present disclosure;

FIG. 7 illustrates a flow diagram of a communication method according to one embodiment of the present disclosure;

FIG. 8 illustrates a flow diagram of a communication method according to one embodiment of the present disclosure; and

FIG. 9 illustrates a block diagram of an example system for wireless communication according to an embodiment of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the present disclosure. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Herein, RAN nodes and base stations refer to gNBs and eNBs.

One of the main objectives specified in RAN2 and RAN3 is to support basic mobility with service continuity for MBS capable RAN nodes and UEs. Regarding this specific objective, three types of UE MBS mobility/handover have been identified and discussed in 3GPP working groups (i.e., RAN2, RAN3 and SA2): (1) mobility from an MBS supporting RAN node to another MBS RAN supporting RAN node; (2) mobility from an MBS supporting RAN node to an MBS not-supporting RAN node; and (3) mobility from an MBS not-supporting RAN node to an MBS supporting RAN node.

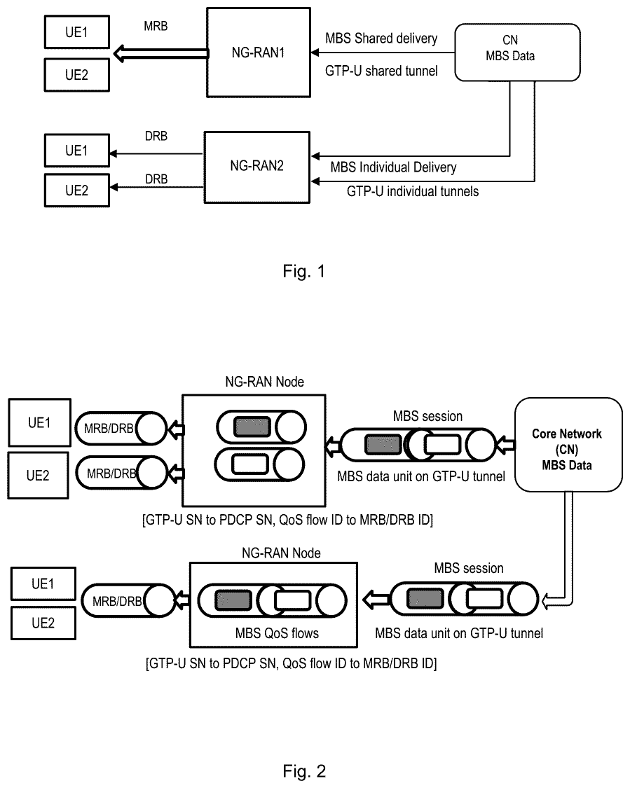

It is also agreed in RAN2 to support lossless MBS mobility based on downlink PDCP SN synchronization and continuity between the RAN nodes. In order to guarantee such MBS mobility/handover, SA2 WG has specified two kinds of deliveries of MBS user data from core network (CN): (1) individual MBS traffic delivery: the 5G CN receives a single copy of MBS data packets and delivers separate copies of those MBS data packets to individual UEs via per-UE PDU sessions over an individual GPRS tunnelling protocol user plane (GTP-U) tunnel; (2) 5GC shared MBS traffic delivery: 5G CN receives a single copy of MBS data packets and delivers a single copy of those MBS data packets to a RAN node over a shared GTP-U tunnel. In addition to that, SA2 has also specified the support of switching between 5GC shared MBS traffic delivery and 5GC individual MBS traffic delivery. FIG. 1 is an illustration of the two kinds of deliveries of MBS user data.

Besides the existing data radio bearer (DRB) used for unicast delivery, 3GPP RAN2 working group has specified a type of new radio bearer to be used for MBS multicast/broadcast delivery, MBS radio bearer (MRB). Moreover, RAN2 has agreed to support that multiple MBS QoS flows corresponding to a same MBS session can be mapped to one or more MBS radio bearers (MRD/DRB). FIG. 2 is an illustration of multiple MBS QoS flows corresponding to a same MBS session mapped to one or more MRB/DRB.

It is still unclear how to fulfill above requirement as stated in the agreement. There may be two possible options to achieve the PDCP SN synchronization and continuity for MBS data delivery.

The first option may be using a common PDCP entity for both RAN nodes (hereinafter source and target) for the associated DRB/MRBs of the MBS session. However, this option is only available for MBS mobility between MBS supporting RAN nodes.

The second option may be PDCP synchronization with one-to-one QoS flow to MRB mapping rules. However, this option is not fully compatible with RAN agreement that “multiple MBS QoS flows corresponding to a same MBS session mapped to . . . more MRB/DRB”.

The present disclosure provides a method for PDCP synchronization and mapping of MBS QoS flows and MRB/DRB which is fully compatible with requirements described in the agreement that “multiple MBS QoS flows corresponding to a same MBS session mapped to one or more MRB/DRB”.

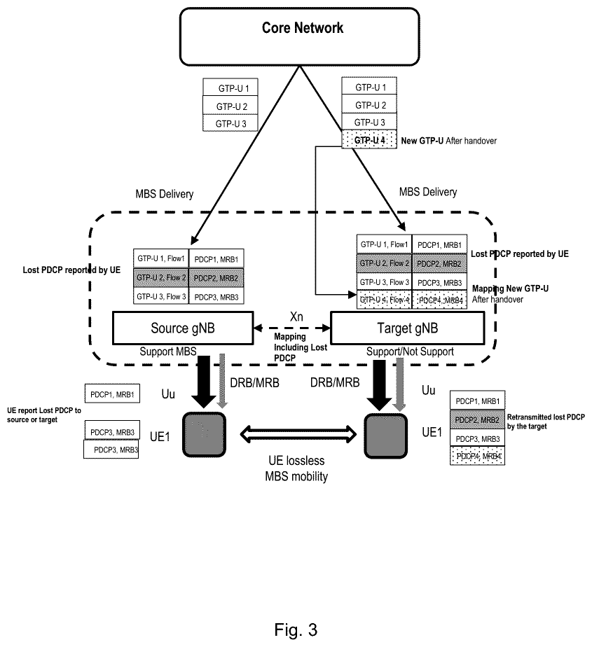

FIG. 3 illustrates an example communication system according to one embodiment of the present disclosure. GTP-U data units and MBS data units may be sent from CN to RAN nodes through individual GTP-U tunnel and MBS delivery or shared GTP-U tunnel and MBS delivery.

According to one embodiment, each GTP-U data unit may have a sequence number (herein after GTP-U SN). In one embodiment, to achieve PDCP synchronization between RAN nodes, RAN nodes which receive those GTP-U data units may be configured to map each GTP-U SN with a PDCP sequence number (herein after PDCP SN).

In a further embodiment, each GTP-U data unit may also be associated with a MBS QoS flow ID, and RAN nodes may be configured to map the QoS flow IDs with MRB/DRB IDs. In one embodiment, mapping information of MBS QoS flow IDs and MRB/DRB IDs may be combined with mapping information of GTP-U SN and PDCP SN (hereinafter combined mapping information).

In one embodiment, RAN nodes may send mapped-to part of the combined mapping information (PDCP SN, MRB/DRB ID) to UEs via for example Uu interface. In other embodiments, RAN nodes may exchange/share the combined mapping information to/with other RAN nodes via for example Xn App, Xn-C or Xn-U interface.

In one embodiment, UE may report to source or target RAN node about lost/incorrectly-received PDCP data units based on the combined mapping information it receives. For example, as illustrated in FIG. 3, PDCP data unit with SN ‘2’ is lost. Therefore, UE may report this lost to source or target RAN node. According to other embodiments, such a report may be triggered by source RAN node's inquiry.

In embodiment, when receiving such report from UE, source RAN node may send/share a complete copy of the combined mapping information to/with the target RAN node. Therefore, the target RAN node may retransmit the lost or incorrectly received PDCP data unit to the UE. Therefore, lossless MBS mobility based on PDCP SN synchronization and continuity between the RAN nodes during handover is achieved.

In one embodiment, the combined mapping information may be transmitted in form of signaling over for example Xn application protocol (XnApp), Xn-C, or Xn-U interface between RAN nodes. For example, a GTP-U data unit of an MBS session may have a sequence number ‘x’ which may be mapped to a PDCP sequence number ‘y’. Also, ID of the QoS flow associated with the GTP-U data unit ‘x’ may have an ID ‘i’, and may be mapped to MRB/DRB with an ID of ‘z’. In one embodiment, the combined mapping information may include two parts (e.g., two octal), for example [GTP-U SN ‘x’, QOS Flow ID ‘i’] mapped to [PDCP SN ‘y’, MRB/DRB ID ‘z’].

In order to ensure that above proposed mapping is fully compatible with the requirement that “multiple MBS QoS flows corresponding to a same MBS session (to be) mapped to one or more MRB/DRB” as described in the agreement, the one to one and one to many mapping modes are discussed as follow.

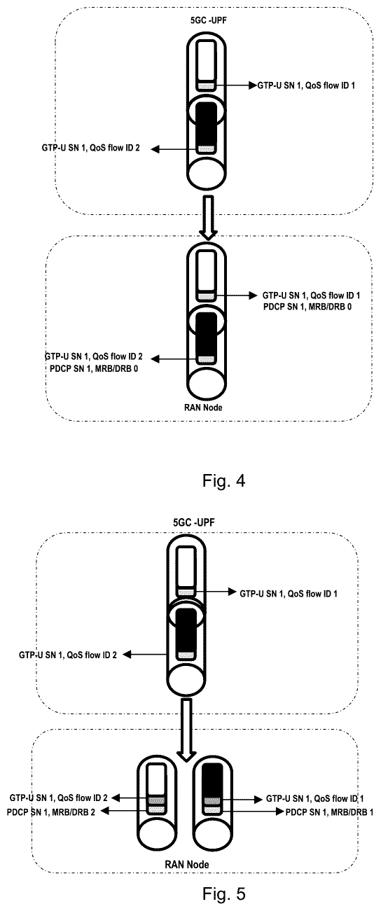

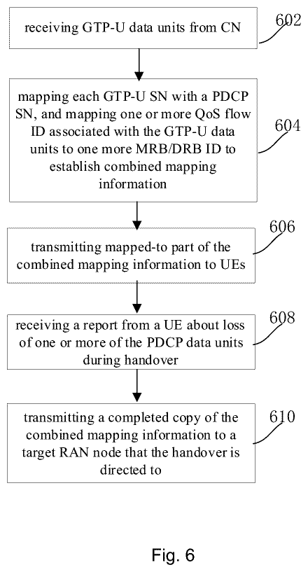

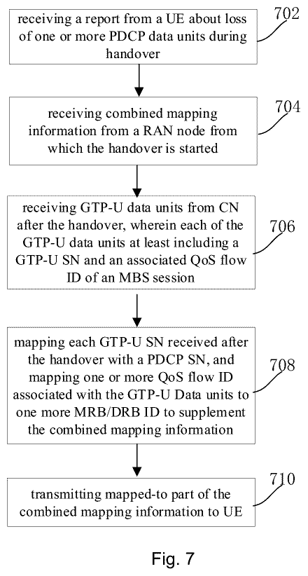

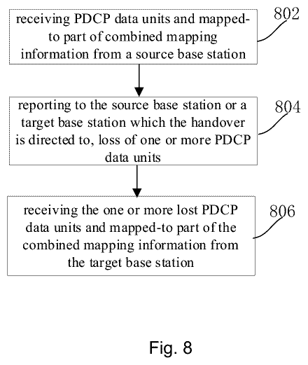

FIG. 4 illustrates a one-to-one mapping mode according to one embodiment of the present disclosure. Table 1 shows examples of a one-to-one mapping mode according to one embodiment of the present disclosure.

TABLE 1

| [GTP-U SN, QoS flow ID] | [PDCP SN, DRB/MRB ID] |
|---|---|
| [1, ½] | [1, 0] |
| [2, ½] | [2, 0] |
| [. . . , . . .] | [. . . , . . .] |

In this mapping mode, when GTP-U data unit's SN is ‘1’, regardless of value of associated QoS flow ID, the GTP-U SN will be mapped to PDCP SN ‘1’. In a further embodiment, as long as the GTP-U SNs are the same, all QoS flow IDs are mapped to a same MRB/DRB ID. In a further embodiment, even the GTP-U SNs are different, all QoS flow IDs are mapped to a same MRB/DRB ID.

As shown in Table 1, [GTP-U SN ‘1’, QOS flow ID ‘1’] and [GTP-U SN ‘1’, QoS flow ID ‘2’] are all mapped to [PDCP SN ‘1’, MRB/DRB ID ‘0’], wherein as long as GTP-U SN is ‘1’, the mapped PDCP SN is ‘1’ as well. Also, even though the two QoS flow IDs associated with the GTP-U data unit ‘1’ are different, they are all mapped to MRB/DRB ID ‘0’.

As shown in Table 1, [GTP-U SN ‘2’, QOS flow ID ‘1’] and [GTP-U SN ‘2’, QoS flow ID ‘2’] are all mapped to [PDCP SN ‘2’, MRB/DRB ID ‘0’], wherein as long as GTP-U SN is ‘2’, the mapped PDCP SN is ‘2’ as well. Also, even though the two QoS flow IDs associated with the GTP-U data unit ‘2’ are different, they are all mapped to MRB/DRB ID ‘0’.

Therefore, this one-to-one mapping mode is compatible with “multiple MBS QoS flows corresponding to a same MBS session (to be) mapped to one . . . MRB/DRB” as described in the agreement.

FIG. 5 illustrates a one-to-many mapping mode according to one embodiment of the present disclosure. Table 2 shows examples of a one-to-many mapping mode according to one embodiment of the present disclosure.

TABLE 2

| [GTP-U SN, QoS flow ID] | [PDCP SN, DRB/MRB ID] |
|---|---|
| [1, ½] | [1, 1] or [1, 2] |
| [2, ½] | [2, 1] or [2, 2] |
| [. . . , . . .] | [. . . , . . .] [. . . , . . .] |

As shown in Table 2, [GTP-U SN ‘1’, QOS flow ID ‘1’] maybe mapped to [PDCP SN ‘1’, MRB/DRB ID ‘1’], and [GTP-U SN 1, QoS flow ID ‘2’] may be mapped to [PDCP SN ‘1’, MRB/DRB ID ‘2’], which indicates that a GTP-U data unit with an SN ‘1’ associated with QoS flow ID ‘1’ or ‘2’ may be mapped to either MRB/DRB ID ‘1’ or MRB/DRB ID ‘2’.

As shown in Table 2, [GTP-U SN ‘2’, QOS flow ID ‘1’] maybe mapped to [PDCP SN ‘2’, MRB/DRB ID ‘1’], and [GTP-U SN 2, QOS flow ID ‘2’] may be mapped to [PDCP SN ‘2’, MRB/DRB ID ‘2’], which indicates that a GTP-U data unit with an SN ‘2’ associated with QoS flow ID ‘1’ or ‘2’ may be mapped to either MRB/DRB ID ‘1’ or MRB/DRB ID ‘2’.

This one-to-many mapping mode enables “multiple MBS QoS flows corresponding to a same MBS session (to be) mapped to . . . more MRB/DRB” as described in the agreement.

In one embodiment, a communication method is provided according to one embodiment of the present disclosure.

At 602, receiving GTP-U data units from CN, wherein each of the GTP-U data units at least includes a GTP-U SN and one or more associated QoS flow ID of an MBS session.

At 604, mapping each GTP-U SN with a PDCP SN, and mapping one or more QoS flow ID associated with the GTP-U data units to one more MRB/DRB ID to establish combined mapping information. In one embodiment, the one or more QoS flow ID associated with a same GTP-U data unit may be mapped to a same MRB/DRB ID. In another embodiment, QoS flow IDs associated with different GTP-U data units may be mapped to a same MRB/DRB ID. In another embodiment, different QoS flow ID associated with a same GTP-U data unit may be mapped to different MRB/DRB IDs respectively.

At 606, transmitting mapped-to part of the combined mapping information to UEs, for example in form of signaling over Uu interface. Of course, the signaling can be of other forms known to those skilled in the art. In one embodiment, the mapped-to part of the combined mapping information may include PDCN SN and MRB/DRB ID.

At 608, receiving a report from a UE about loss of PDCP data units during handover.

At 610, transmitting a completed copy of the combined mapping information to a target RAN node that the handover is directed to, for example in form of signaling over XnApp, Xn-C, or Xn-U interface. Of course, the signaling can be of other forms known to those skilled in the art. Therefore, the target RAN node may retransmit the lost PDCP data units to the UE.

In one embodiment, an exemplary functionality of a RAN node or base station may be operable for above communication. The base station may comprise one or more processors. The one or more processors can be configured to perform operations stated above. In one embodiment, the RAN node configured to perform the method may be a source RAN node from which handover starts.

In one embodiment, a communication method is provided according to one embodiment of the present disclosure.

Optionally, at 702, receiving a report from a UE about loss of PDCP data units during handover. In other embodiment, the report may be sent to the source instead of the target RAN node.

At 704, receiving combined mapping information from a source RAN node from which the handover is started, for example in form of signaling over XnApp, Xn-C, or Xn-U interface. Of course, the signaling can be of other forms known to those skilled in the art. In one embodiment, the combined mapping information includes mapping information of GTP-U SNs and PDCP SNs, as well as mapping information of QoS flow IDs (associated with the GTP-U data unit s) and MRB/DRB IDs.

Optionally, at 706, receiving GTP-U data units from CN after the handover, wherein each of the GTP-U data units at least including a GTP-U SN and one or more associated QoS flow IDs of an MBS session, when new GTP-U is introduced after handover.

Optionally, at 708, mapping each GTP-U SN received during or after the handover with a PDCP SN, and mapping one or more QoS flow ID associated with the GTP-U data units to one more MRB/DRB ID to supplement the combined mapping information. In one embodiment, the one or more QoS flow ID associated with a same GTP-U data unit may be mapped to a same MRB/DRB ID. In another embodiment, QoS flow IDs associated with different GTP-U data units may be mapped to a same MRB/DRB ID. In another embodiment, different QoS flow ID associated with a same GTP-U data unit may be mapped to different MRB/DRB IDs.

At 710, transmitting mapped-to part of the combined mapping information to UEs, for example in form of signaling over Uu interface. Of course, the signaling can be of other forms known to those skilled in the art. In one embodiment, the mapped-to part of the combined mapping information may include PDCN SN and MRB/DRB ID. In one embodiment, the lost PDCP data units are also retransmitted to UE.

In one embodiment, an exemplary functionality of a RAN node or base station may be operable for above communication. The base station may comprise one or more processors. The one or more processors can be configured to perform operations stated above. In one embodiment, the RAN node configured to perform the method may be a target RAN node to which the handover is directed.

In one embodiment, a communication method is provided according to one embodiment of the present disclosure.

At 802, receiving PDCP data units and mapped-to part of f combined mapping information from a source RAN node from which handover starts, wherein the combined mapping information includes mapping information of GTP-U SNs and PDCP SNs, as well as mapping information of QoS flow IDs and MRB/DRB IDs. In one embodiment, the one or more QoS flow ID associated with a same GTP-U data unit may be mapped to a same MRB/DRB ID. In another embodiment, QoS flow IDs associated with different GTP-U data units may be mapped to a same MRB/DRB ID. In another embodiment, different QoS flow ID associated with a same GTP-U data unit may be mapped to different MRB/DRB IDs.

At 804, reporting to the source RAN node or a target RAN node that the handover is directed to, loss of one or more of the PDCP data units.

At 806, receiving a complete copy of mapped-to part of the combined mapping information from the target base station, for example in form of signaling over Uu interface. Of course, the signaling can be of other forms known to those skilled in the art. In one embodiment, the mapped-to part of the combined mapping information may include PDCN SN and MRB/DRB ID. In one embodiment, the lost PDCP data units are also retransmitted to UE.

In one embodiment, an exemplary functionality of a UE may be operable for above communication. The UE may comprise one or more processors. The one or more processors can be configured to perform operations stated above.

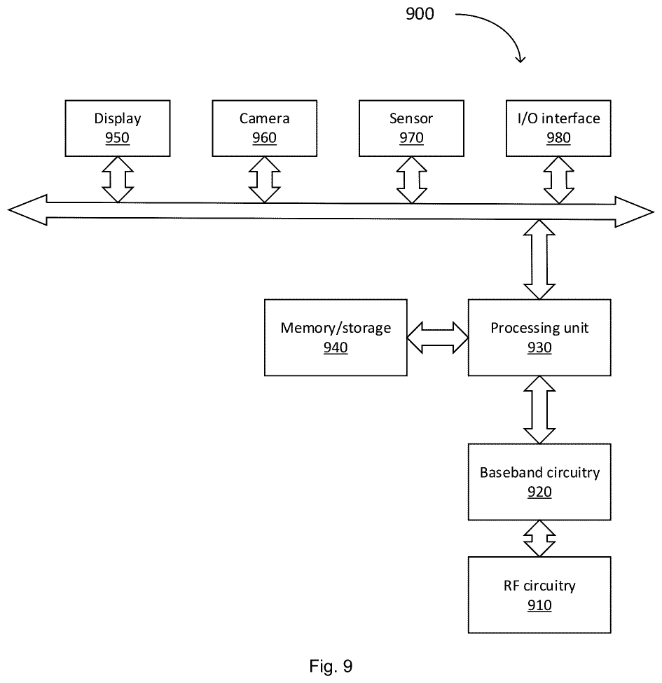

FIG. 9 illustrates a block diagram of an example system for wireless communication according to an embodiment of the present disclosure. Embodiments described herein may be implemented into the system using any suitably configured hardware and/or software. FIG. 9 illustrates the system 900 including a radio frequency (RF) circuitry 910, a baseband circuitry 920, a processing unit 930, a memory/storage 940, a display 950, a camera 960, a sensor 970, and an input/output (I/O) interface 980, coupled with each other as illustrated.

The processing unit 930 may include circuitry, such as, but not limited to, one or more single-core or multi-core processors. The processors may include any combinations of general-purpose processors and dedicated processors, such as graphics processors and disclosure processors. The processors may be coupled with the memory/storage and configured to execute instructions stored in the memory/storage to enable various disclosures and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 920 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 900 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

Embodiments in the present disclosure enables UE with lossless MBS mobility. In those embodiments, UE may receive mapping information of QoS flow IDs to MRB/DRB IDs immediately when processing of the PDCP layer, which can help reducing UE's processing overhead, for example, by skipping SDAP layer processing. In other words, as long as a UE receives PDCP data units it will be aware of mapping information of QoS flow to DRB, therefore there is no need to perform SDAP layer processing.

In those embodiments, combined mapping information is exchanged/shared among RAN nodes, PDCP synchronization and continuity for the UE moving between the RAN nodes can be guaranteed, with involvement of CN, RAN nodes manage PDCP to GTU-P allocation.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A communication method for lossless MBS transmission, executable in a base station, comprising:
mapping a GTP-U SN with a PDCP SN, and mapping one or more QoS flow IDs associated with the GTP-U data units to one more MRB/DRB ID to establish combined mapping information; and
transmitting the combined mapping information to a target base station that the handover is directed to.

2. The method of claim 1, wherein mapping each GTP-U SN with a PDCP SN, and mapping one or more QoS flow ID associated with the GTP-U data units to one more MRB/DRB ID to establish combined mapping information includes:
mapping the GTP-U SN within the GTP-U data unit to a PDCP SN and mapping the one or more QoS flow ID associated with a same GTP-U data unit to a same MRB/DRB ID.

3. The method of claim 1, wherein mapping each GTP-U SN with a PDCP SN, and mapping one or more QoS flow ID associated with the GTP-U data units to one more MRB/DRB ID to establish combined mapping information includes:
mapping the GTP-U SN within the GTP-U data unit to a PDCP SN and mapping QoS flow IDs associated with different GTP-U data units to a same MRB/DRB ID.

4. The method of claim 1, wherein mapping each GTP-U SN with a PDCP SN, and mapping one or more QoS flow ID associated with the GTP-U data unit to one more MRB/DRB ID to establish combined mapping information includes:
mapping the GTP-U SN within the GTP-U data unit to a PDCP SN and mapping different QoS flow IDs associated with a same GTP-U data unit to different MRB/DRB IDs respectively.

5. The method of claim 1, wherein the mapped-to part of the combined mapping information is transmitted to UEs via Uu interface.

6. The method of claim 1, wherein the combined mapping information is transmitted to a target base station that the handover is directed to via XnApp, Xn-C or Xn-U interface.

7. A base station, comprising:
a processor, configured to call and run a computer program stored in a memory to execute a communication method for lossless MBS transmission comprising:
mapping a GTP-U SN with a PDCP SN, and mapping one or more QoS flow IDs associated with the GTP-U data units to one more MRB/DRB ID to establish combined mapping information; and
transmitting the combined mapping information to a target base station that the handover is directed to.

8. The base station of claim 7, wherein mapping each GTP-U SN with a PDCP SN, and mapping one or more QoS flow ID associated with the GTP-U data units to one more MRB/DRB ID to establish combined mapping information includes:
mapping the GTP-U SN within the GTP-U data unit to a PDCP SN and mapping the one or more QoS flow ID associated with a same GTP-U data unit to a same MRB/DRB ID.

9. The base station of claim 7, wherein mapping each GTP-U SN with a PDCP SN, and mapping one or more QoS flow ID associated with the GTP-U data units to one more MRB/DRB ID to establish combined mapping information includes:
mapping the GTP-U SN within the GTP-U data unit to a PDCP SN and mapping QoS flow IDs associated with different GTP-U data units to a same MRB/DRB ID.

10. The base station of claim 7, wherein mapping each GTP-U SN with a PDCP SN, and mapping one or more QoS flow ID associated with the GTP-U data unit to one more MRB/DRB ID to establish combined mapping information includes:
mapping the GTP-U SN within the GTP-U data unit to a PDCP SN and mapping different QoS flow IDs associated with a same GTP-U data unit to different MRB/DRB IDs respectively.

11. The base station of claim 7, wherein the mapped-to part of the combined mapping information is transmitted to UEs via Uu interface.

12. The base station of claim 7, wherein the combined mapping information is transmitted to a target base station that the handover is directed to via XnApp, Xn-C or Xn-U interface.

13. A communication method, executable in a base station, comprising:
receiving combined mapping information from a source base station from which the handover is started, wherein the combined mapping information includes mapping information of GTP-U SNs and PDCP SNs, as well as mapping information of QoS flow IDs and MRB/DRB IDs; and
transmitting mapped-to part of the combined mapping information to UEs, wherein the mapped-to part of the combined mapping information includes PDCN SN and MRB/DRB ID.

14. The method of claim 13, further comprising
receiving a report from a UE about loss of one or more PDCP data units during handover; and
transmitting reported the one or more reported lost PDCP data units to the UE.

15. The method of claim 13, further comprising
receiving GTP-U data units from CN after the handover, wherein each of the GTP-U data units at least including a GTP-U SN and one or more associated QoS flow IDs of an MBS session; and
mapping each GTP-U SN received after the handover with a PDCP SN, and mapping one or more QoS flow ID associated with the GTP-U data units to one more MRB/DRB ID to supplement the combined mapping information

16. The method of claim 13, wherein the QoS flow IDs associated with a same GTP-U data unit are mapped to a same MRB/DRB ID.

17. The method of claim 13, wherein the QoS flow IDs associated with different GTP-U data units are mapped to a same MRB/DRB ID.

18. The method of claim 13, wherein different QoS flow ID associated with a same GTP-U data unit are mapped to different MRB/DRB IDs respectively.

19. The method of claim 14, wherein the report is received from the UE and the mapped-to part of the combined mapping information is transmitted to the UE via Uu interface.

20. The method of claim 13, wherein the combined mapping information is received from the source base station from which the handover is started via XnApp, Xn-C, or Xn-U interface.
